(19) United States
(12) Patent Application Publication
(10) Pub. No.: US 2015/0188718 A1
(43) Pub. Date: Jul. 2, 2015

(54) Providing a Cryptographic Key

(71) Applicant: Rainer Falk, Poing (DE)

(72) Inventor: Rainer Falk, Poing (DE)

(21) Appl. No.: 14/583,689

(22) Filed: Dec. 27, 2014

(30) Foreign Application Priority Data
Dec. 27, 2013 (DE) 102013227166.2

(51) Int. Cl. H04L 9/32; H04L 9/08

(52) U.S. Cl. CPC H04L 9/3278; H04L 9/0816; H04L 2209/24

(57) ABSTRACT

A circuit unit for providing a cryptographic key is provided. The circuit unit includes a physical unclonable function for generating a response value in response to a challenge value. The circuit unit also includes a determination unit for determining a plurality of challenge values and for inputting the plurality of challenge values to the physical unclonable function in order to generate a plurality of response values. The circuit unit includes a comparison unit for providing a comparison result by comparing the generated plurality of response values with a predefined reference value, and a provision unit for providing one challenge value of the plurality of challenge values as the cryptographic key based on the comparison result provided.

This application claims the benefit of DE 10 2013 227 166.2, filed on Dec. 27, 2013, which is hereby incorporated by reference in its entirety.

### BACKGROUND

The present embodiments relate to providing a cryptographic key.

A cryptographic key is provided for many applications. It is known practice to randomly generate a cryptographic key. However, if the key is not intended to be manually input for each use, the key is to be stored in a memory module. Physically protected hardware modules (e.g., crypto controller, secure memory modules), for example, may be used for secure storage. A cryptographic key may also be stored in obfuscated form (e.g., in a form in which the key may be determined by an outsider only with a certain amount of analysis).

Physical unclonable functions (PUFs) in a semiconductor circuit are known. Different types of PUFs exist, as is explained, for example, at https://www.cosic.esat. kuleuven.be/ecrypt/courses/albena11/slides/ingrid_verbauwhede_pufs.pdf. For example, an SRAM PUF may be used to determine a key based on the memory content of an SRAM memory after being switched on. Ring oscillator PUFs and arbiter PUFs that provide a response value based on a challenge value are also known.

Also, it is known practice to extract a cryptographic key by a fuzzy key extractor using a PUF. However, a fuzzy key extractor uses auxiliary data (e.g., helper data) that is to be generated when storing a key. The data is also to be stored, for which a non-volatile memory is used. An overview of PUF-based key generation is provided, for example, by http://www.cosic.esat.kuleuven.be/publications/article-2323.pdf (M. Yu, D. M'Raïhi, S. Devadas, and I. Verbauwhede, “Security and Reliability Properties of Syndrome Coding Techniques Used in PUF Key Generation”, in GOMACTech conference 38, GomacTech, pp. 1-4, 2013).

Auxiliary data that is to be generated during an initialization phase are used in the known methods. The data is to be stored in a non-volatile memory, for which a suitable memory module is used. In addition, when designing the key extractor, the stored data are not to contain any hidden information on the key. For example, if the error correction code is “too good”, the key may be extracted from the public auxiliary data even without a PUF.

http://people.csail.mit.edu/devadas/pubs/host2011.pdf (Zdenek (Sid) Paral, Srinivas Devadas: Reliable and Efficient PUF-Based Key Generation Using Pattern Matching, IEEE Int'l Symposium on Hardware-Oriented Security and Trust (HOST), 2011) describes a method for determining a key using pattern matching of the PUF responses. This is also described in WO 2012/099657 A2, which discloses the practice of generating a cryptographic key without a fuzzy key extractor using a challenge-response PUF. For this purpose, pattern matching is carried out with the PUF response values generated using a predefined sequence of challenge values. The position (e.g., the index) of the element in the sequence of response values, at which a particular desired response pattern occurs for the first time, is used in this case as information for determining the key. During the initialization phase, the response value that occurs at that location (e.g., index) in the sequence of response values at which the index value corresponds to the key value is stored as the reference pattern.

In this method, an initialization phase, in which auxiliary data (e.g., the bit patterns used to reconstruct the key) are stored, is carried out. Any desired key to be reconstructed, for which key corresponding auxiliary data are determined and stored during production, for example, may be predefined. In this case, for a particular desired key or cryptographic key, it is determined during the initialization phase which bit pattern is present at the position in the sequence that corresponds to the desired key value. The fact that the determined bit pattern or a sufficiently similar bit pattern also already occurs at an earlier position may not be excluded. The desired key may not be correctly reconstructed.

Haile Yu, Philipp Leong, Qiang Xu: An FPGA Chip Identification Generator using Configurable Ring Oscillators, IEEE Trans. VLSI Syst. 20(12): 2198-2207 (2012), http://www.ee.usyd.edu.au/people/philip.leong/UserFiles/File/papers/id_tvlsi12.pdf, describes a method for determining a stable ID (e.g., “serial number”) from a configurable PUF without auxiliary data on an FPGA. For this purpose, a bit of the ID is determined using a configurable PUF by determining the residue for all possible configurations of the PUF. In this case, the residue is the “raw response” (e.g., the difference between the counter values of the ring oscillator PUFs used). The configuration of the PUF for which the absolute value of the residue is at a maximum is now determined. The mathematical sign of the maximum residue reveals the determined polarity of the PUF (e.g., the associated bit of the ID). If a safety margin for clearly determining the polarity is not achieved in a PUF, the range of the considered configurations of the PUF is iteratively restricted according to a fixed criterion (e.g., lower half of the configurations corresponding to the configuration index) until a result at which the residue is sufficiently clear may be determined. Even if the plurality of configurations of a PUF are interpreted as a challenge, the result (e.g., polarity/bit is 0 or 1) is determined based on the PUF raw response or the residue (e.g., the difference between the counter values of a ring oscillator PUF).

WO 2010/060005 A2 describes the fact that a circuit contains a challenge generator that generates a sequence of challenge values applied to a PUF of the circuit. A response value is determined from the raw response data (e.g., inner response) by postprocessing. The response value is passed to the outside. US 2013/010957 A1 discloses the practice of using a cryptographic key that is determined using a PUF and contains bit errors, directly (e.g., without a downstream key extractor), for secure communication with a communication partner.

http://rijndael.ece.vt.edu/puf/paper/fpl2009.pdf (Abhranil Maiti, Patrick Schaumont: IMPROVING THE QUALITY OF A PHYSICAL UNCLONABLE FUNCTION USING CONFIGURABLE RING OSCILLATORS, pp. 703-707 In proceeding of: 19th International Conference on Field Programmable Logic and Applications, FPL 2009, Aug. 31-Sep. 2, 2009, Prague, Czech Republic) discloses the practice of implementing a PUF in such a robust manner that only a small number of bit errors are to be corrected for key extraction. As a result, a simpler error correction code may be used for key extraction. This reduces but does not avoid the necessary amount of implementation effort for error correction (e.g., key extractor).

Cryptographic puzzles in which an entity is to correctly guess a value are also known. For this purpose, a cryptographic hash function such as SHA-1, SHA256, SHA3 etc. may be used, for example. A target value is predefined for the entity. The entity is to try out a certain range of values (e.g., 16 bits) in order to determine the input value that corresponds to the predefined output value. A certain amount of computation (e.g., time) is required for this purpose. It is known practice, for example, to use such cryptographic puzzles to protect against denial-of-service attacks. A requesting party is to solve a cryptographic puzzle presented to the requesting party before the request is processed. Cryptographic puzzles are described, for example, at http://www.aut.upt.ro/˜bgroza/Papers/puz.pdf, http://link.springer.com/article/10.1007%2Fs10623-013-9816-5#.

Side channel attacks against implementations of cryptographic algorithms, in which a cryptographic key used is inferred based on power consumption, runtime behavior or electromagnetic radiation, are known. In the case of correlation attacks (see http://en.wikipedia.org/wiki/Correlation_attack), a correlation between the expected radiation pattern of a hypothetical key (e.g., partial key) and the actually observed radiation pattern is calculated. Also see, in this respect, http://homes.esat.kuleuven.be/˜iverbauw/IndoPartIToWebsite.pdf, slide 43 ff.

Key extraction from PUF responses using correction data is described, for example, in U.S. Pat. No. 7,681,103 B2 and WO 2010/100015 A1.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a cryptographic key is provided without additional auxiliary data in a simple and secure manner.

A circuit unit for providing a cryptographic key is provided. The circuit unit includes a physical unclonable function (PUF) for generating a response value in response to a challenge value. The circuit unit also includes a determination unit for determining a plurality of challenge values and for inputting the plurality of challenge values to the physical unclonable function in order to generate a plurality of response values. The circuit unit includes a comparison unit for providing a comparison result by comparing the generated plurality of response values with a predefined reference value, and a provision unit for providing one challenge value of the plurality of challenge values as the cryptographic key based on the comparison result provided.

Cryptographic keys are provided to use cryptographic security mechanisms. A cryptographic key may be generated and stored in a memory in order to avoid having to manually input the key for each use. In this case, the cryptographic key may be provided in a repeated or reproducible manner. In the proposed circuit unit, a cryptographic key is determined using hardware-intrinsic properties of the semiconductor circuit using a physical unclonable function (PUF). The cryptographic key may be securely provided on an embedded device and may be used to protect fixed or configurable stored data or program code of the embedded system.

According to the circuit unit (e.g., circuit), a challenge-response physical unclonable function (CR-PUF) of the circuit, which may be an FPGA or ASIC, for example, is used to provide a data value, which is a cryptographic key or an identifier, in a reproducible manner. No auxiliary data that would have to be stored in a non-volatile memory are required for this purpose.

The CR-PUF is a function that is implemented in the circuit and provides a response value in response to a challenge value (e.g., bit strings with a length of 8, 16, 32, 64, 128, 256 or 512 bits). The response values to a challenge value are different in different circuit specimens (e.g., a large number of different bits), but are similar in one circuit specimen (e.g., only a certain number of different bits). A PUF response may be composed of a plurality of response fractional values if an implementation of the raw CR-PUF has a shorter response length. A longer PUF response may be composed, for example, of a CR-PUF that determines only one output bit for a challenge value, for example. In this case, 3 bits of the input challenge (e.g., with a range of decimal values from 0 to 7) may be used, for example, to determine a response with a length of 8 bits.

Based on a PUF, a value is determined as the cryptographic key, from a predefined range of values that is highly likely to be identical on one chip during repeated execution but is different on different chips. A cryptographic key is also understood as being an identifier or key derivation parameter below.

For example, the intention is to determine an 8-bit fractional value from the range of values of 0 to 255 as the cryptographic key. For this purpose, at least one challenge value (e.g., request value) is determined in the determination unit for each candidate fractional value according to a fixed, predefined calculation rule. 256 challenge values are therefore determined for an exemplary range of values of 0 to 255. The determination unit then applies the determined challenge values to the PUF. An associated response value is therefore generated for each challenge value. The response values are compared with an expected reference value by the comparison unit that provides a comparison result. One challenge value of the plurality of challenge values is provided as the cryptographic key based on the comparison result.

The comparison or reference value is fixed, with the result that the comparison or reference value does not need to be determined and stored. However, different but fixed reference values may be used in each case for different fractional values or different values of a plurality of possible determinable values.

In conventional methods, a cryptographic key is generated and is stored in a protected manner. In contrast, in the circuit unit proposed, a cryptographic key is determined directly in a reproducible manner using a PUF. Although a particular key therefore may not be predefined, this has the advantage that there is no need for any initialization, and there is no need to store auxiliary data for key reconstruction. There is also no need to additionally generate a key that then has to be stored. Since a key may not be predefined, but rather a key results, this arbitrary key may be used for the internal self-protection of an embedded device (e.g., protected storage of configuration data).

According to one embodiment, a response value corresponds to a response pattern, and the predefined reference value corresponds to a reference pattern. The comparison unit is configured to compare a respective response pattern with the reference pattern.

A type of pattern recognition is therefore carried out when comparing the reference value with the response values. For a plurality of possible keys (e.g., challenge values), the key for which an expected pattern (e.g., the reference pattern) is most clearly present in the response pattern is determined by trying out. The comparison or reference pattern is fixed, as already explained, with the result that the comparison or reference pattern does not need to be determined and stored.

According to another embodiment, the comparison unit is configured to determine a similarity measure between the plurality of response values and the predefined reference value.

When comparing the reference value or pattern with the respective response values or patterns, a similarity measure between the respective response pattern and the reference response value (e.g., “matching”) may be determined. The provision unit may provide the challenge value with a response value that has the highest similarity measure as the result.

According to another embodiment, the similarity measure has information relating to the match of the number of bits between a respective response value and the predefined reference value.

The number of different bits (e.g., the Hamming distance) may be used as the similarity measure, for example.

According to another embodiment, each challenge value of the plurality of challenge values is a fractional value of an overall range of values.

As explained above, an 8-bit fractional value, for example, may be determined from the overall range of values of 0 to 255 as the cryptographic key. For this purpose, at least one challenge value is determined in the determination unit for each candidate fractional value according to a fixed, predefined calculation rule. 256 challenge values are therefore determined for an exemplary range of values of 0 to 255. A challenge value may also have 12 bits, 4 bits, 2 bits, 1 bit or any other length.

According to another embodiment, the determination unit is configured to select the fractional values from the overall range of values according to a predefined scheme.

Different determination rules may be provided for the purpose of forming a challenge value. For example, some bits of the challenge values may be firmly predefined, or the challenge values may be deterministically calculated. A plurality of PUF challenge values may also be determined for a challenge value and are applied to the PUF.

The range of values may be run through in a particular search sequence. For example, the scheme may be based on a starting value or a search sequence (e.g., linear, hopping, multiplication, cyclical (cyclic code), or other strategies). In one variant, the search sequence may be run through in a randomized manner. In this case, the sequence is determined based on a value determined at the runtime using a random number generator.

According to another embodiment, the challenge value of the plurality of challenge values that is provided as the cryptographic key is a cryptographic partial key of a complete key.

A complete key may include a plurality of partial keys. In this case, the determination is carried out for each partial key that is combined at the end. For example, an 8-bit partial key may be respectively determined in order to compose a cryptographic key having 128 bits, 256 bits or the like byte by byte. The complete key may be determined by concatenating the partial keys, for example.

According to another embodiment, the comparison unit is configured to compare the generated plurality of response values with a plurality of predefined reference values, and the provision unit is configured to determine a plurality of partial keys based on the comparison results.

The individual partial keys may be determined using a plurality of reference values. A plurality of keys may also be extracted from a PUF. An intended purpose (e.g., a purpose determination parameter) of the key may be included in the challenge determination and/or the reference value selection/determination for this purpose.

According to another embodiment, the determination unit is configured to repeatedly input each of the plurality of challenge values to the physical unclonable function in order to determine a plurality of response values for each challenge value.

A plurality of response values may be determined for a challenge value by repeated application to the PUF. Random bit errors may be averaged out in this manner.

A plurality of response values of a PUF may also be concatenated. In this case, a plurality of PUF challenge values are determined based on the checked challenge value of the partial key according to a determination rule.

This has the advantage that the length of a PUF response value used for the comparison may be selected to be greater than the size of the response value of a CR-PUF implemented using circuitry. As a result, a CR-PUF that provides only an individual response bit for a challenge value predefined to it may be used. In this case, a plurality of response bits (e.g., 8, 12 or 16 bits) are therefore combined (e.g., concatenated) to form a response or a response value. The response composed in this manner is then used for the comparison, as described above. In one variant, the checked challenge value is combined with a counter value (e.g., 3 bits or 4 bits). The plurality of partial responses for a checked challenge value are determined by combining the checked challenge value with all or at least some of the possible counter values and respectively applying this combined challenge value to the PUF. In order to determine a response used for the comparison, a combined challenge or challenge value is therefore repeatedly applied to the CR-PUF.

According to another embodiment, the provision unit is configured to provide a plurality of possible challenge values.

According to this embodiment, a plurality of candidates may be provided for a challenge value. The three challenge values with the highest match may be provided as possible challenge values, for example.

According to another embodiment, the circuit unit has a test unit for checking the possible challenge values with the aid of test data and for selecting one challenge value of the possible challenge values as the cryptographic key.

In order to select one of the possible challenge values as the cryptographic key, the test unit may check these values with the aid of test data. For this purpose, the individual possible challenge values are used as cryptographic keys for test purposes. This use is checked, and the challenge value with the best results is provided as the cryptographic key.

According to another embodiment, the plurality of response values and the reference value differ in terms of the length.

In one variant, the comparison unit (e.g., matcher) does not search for a similarity between the response values and the reference value with fixed patterns of the same length but rather, correlates the response pattern to a reference pattern (e.g., a shorter reference pattern). In this case, not only the number of different or identical bits is checked but rather, how often a similar signal occurs in the longer sequence.

According to another embodiment, the comparison unit is configured to replace the predefined reference value with a further predefined reference value.

A plurality of reference values may also be used. The reference value that provides the highest maximum value (e.g., the highest match) over all challenge values may be selected for future use.

The circuit unit for determining a key using a PUF does not require any auxiliary data. The auxiliary data would have to be determined (e.g., enrollment) and stored in a non-volatile memory. The circuit unit may be implemented, for example, directly internally as an autonomous module using the bit stream inside an FPGA or the like. The autonomous module does not require any interface to a configuration memory with stored auxiliary data.

The method may be used for any desired challenge-response PUFs and not only for configurable ring oscillator PUFs. In addition, only access to the external interface of a challenge-response PUF may be provided, but not access to internal residues.

There is no need to implement an error correction method such as BCH codes, RS codes or the like, but rather, only simple functions that may be implemented in a resource-saving manner are used as a digital circuit. The cryptographic key may not be predefined, but results may be. This property is suitable, for example, if only an embedded device itself would like to protect sensitive configuration data. This provides that the same device stores and reads configuration data (e.g., there is no communication with a second communication partner).

One or more of the present embodiments relate to a method for providing a cryptographic key. The method includes determining a plurality of challenge values, inputting the plurality of challenge values to a physical unclonable function (PUF) in order to generate a plurality of response values in response to the challenge values, and providing a comparison result by comparing the generated plurality of response values with a predefined reference value. The method also includes providing one challenge value of the plurality of challenge values as the cryptographic key based on the comparison result provided.

A computer program product that causes the method explained above to be carried out on a program-controlled device is also provided.

A computer program product (e.g., a computer program device) may be provided or delivered, for example, as a non-transitory computer-readable storage medium (e.g., a memory card, a USB stick, a CD-ROM, a DVD) or else in the form of a downloadable file from a server in a network. This may be effected, for example, in a wireless communication network, by transmitting a corresponding file containing the computer program product.

The embodiments and features described for the circuit unit accordingly apply to the proposed method.

Further possible implementations also include not explicitly mentioned combinations of features or embodiments described above or described below with respect to the exemplary embodiments. In this case, a person skilled in the art will also add individual aspects as improvements or additions to the respective basic form of the invention.

### BRIEF DESCRIPTION OF THE DRAWINGS

FIG. 1 shows a schematic block diagram of a first exemplary embodiment of a circuit unit for providing a cryptographic key;

FIG. 2 shows a schematic block diagram of a second exemplary embodiment of a circuit unit for providing a cryptographic key;

FIG. 3 shows an exemplary match table for use in the circuit unit from FIG. 2; and

FIG. 4 shows a flowchart of an exemplary embodiment of a method for providing a cryptographic key.

### DETAILED DESCRIPTION

In the figures, same or functionally same elements have been provided with the same reference symbols unless stated otherwise.

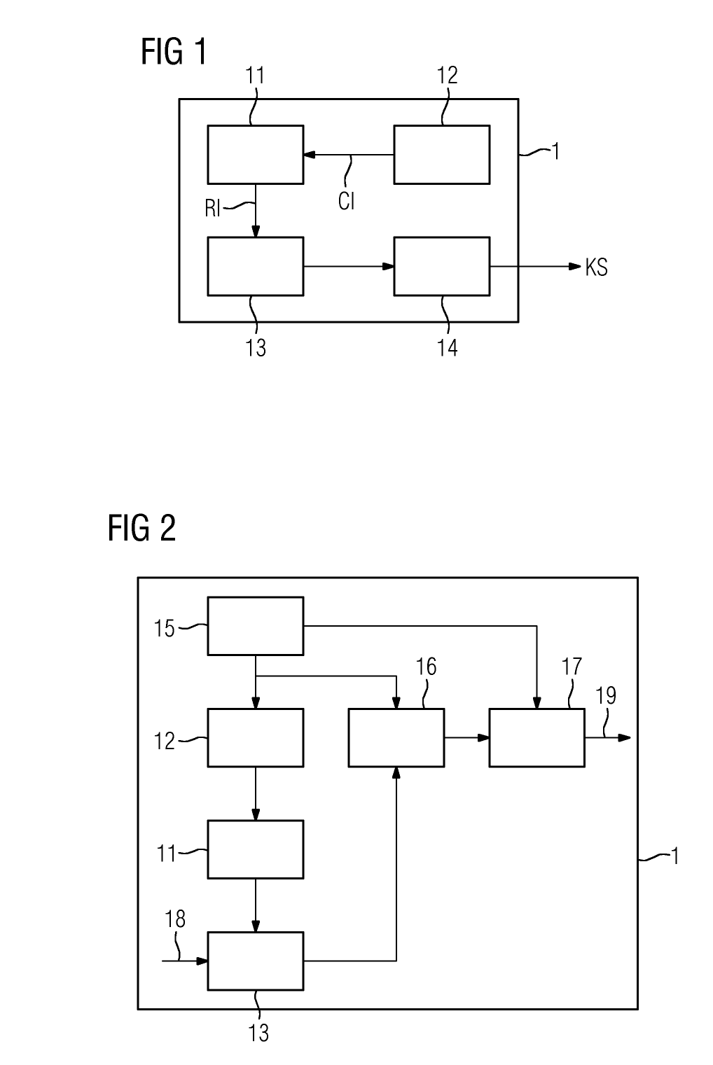

FIG. 1 shows an embodiment of a circuit unit 1 for providing a cryptographic key KS.

The circuit unit 1 includes a physical unclonable function (PUF) 11 for generating a response value RI in response to a challenge value CI. A determination unit 12 determines a plurality of challenge values CI and inputs the plurality of challenge values CI to the PUF 11 (e.g., applies the challenge values CI to the PUF 11).

The PUF 11 generates a response value RI for each challenge value CI and transmits the response value R1 to a comparison unit 13. The comparison unit 13 compares each response value RI with a predefined reference value 18 and provides a provision unit 14 with the comparison result. The provision unit 14 provides one challenge value CI of the plurality of challenge values CI as the cryptographic key KS based on the comparison result provided. The determination unit 12, the comparison unit 13, and the provision unit 14 may be formed by one or more processors. The one or more processors may be the same as or different than the PUF 11.

FIG. 2 shows one embodiment of a circuit unit 1 for determining a partial key 19 (e.g., sub-key) that is part of the cryptographic key KS.

The sub-key 19 may be an 8-bit value, for example. This value may assume the possible values of 0-255 (decimal) or 0000 0000-1111 1111 (binary). The aim is to determine a particular sub-key 19. For this purpose, the partial key generator (e.g., sub-key sequencer) 15 generates all possible values of the sub-key 19. This may be effected, for example, in a successive sequence, but other sequences may also be provided.

For each possible candidate (e.g., possible partial key), an associated challenge value CI is determined by a “challenge determination” in the determination unit 12. The challenge value CI is applied to the CR-PUF. The response value RI determined is checked by the matcher 13 in order to determine whether the response value RI has a predefined reference pattern 18 or to determine the extent to which the response value R1 resembles the reference pattern. The result may have a hard form (e.g., true/false) or may be in the form of a soft value (e.g., in the form of the value 0-7, which indicates a measure of the presence of the pattern, determines a cross-correlation). Based on the value determined by the matcher 13, the entry that corresponds to the sub-key 19 currently provided by the sub-key sequencer 15 is updated in a match table 16 (e.g., sub-key match counting table). The match with one or more reference patterns 18 may be effected directly (e.g., XOR operation bit by bit). A feature extraction from the response value RI may also be carried out (e.g., Hamming weight, number of bit changes in the bit string, number of n-bit strings with an identical bit value), and the match result (e.g., matching result) may be determined in the match determination unit 17 using the extracted features of the response value.

When the sub-key sequencer 15 has run through all values, the match determination unit 17 (e.g., maximum match selection) is provided with a signal indicating that the match table 16 may be evaluated. For this purpose, the sub-key 19 of the sub-key entry with the best match result is provided, for example.

In the case of only one run with a fixed pattern and a hard matcher, only a value of 0 or 1 may occur as the “match count” (e.g., the match measure). Since no enrollment or initialization of auxiliary data occurs, it is possible to only statistically state how many matches occur. Therefore, it is not possible to exclude the fact that no entry or a plurality of entries possibly has/have an entry of 1 in such a simple variant. No result or no clear result may then be determined. This may be solved by using the smallest, the largest, the second, etc. sub-key value, for example. In one variant, all matching sub-key values (e.g., challenge values CI) may be combined (e.g., XOR operation) in order to determine the output sub-key value 19.

One implementation carries out a multi-value match count (e.g., a determination in which a match is defined by a plurality of values). One of the following possibilities may be used in this case.

It is possible to use a “soft decision matcher” that does not output only 0 or 1 but rather a multi-value result relating to the degree of pattern match. The soft decision matcher may state, for example, the number of bit discrepancies (e.g., Hamming distance) for the same bit length of the response pattern and the reference pattern. In another variant, the two patterns have different lengths. The two patterns may then be shifted bit by bit, and the number of matching bits may be detected for each offset. The match between a response pattern and a plurality of reference patterns may be checked. The overall match result may be determined as a maximum or minimum value, for example, by addition.

Alternatively, the range of values may be run through repeatedly. In this case, identical challenge values with an identical reference pattern are used. The overall match result may be determined, for example, by a maximum value, a minimum value, a median value or a mean value.

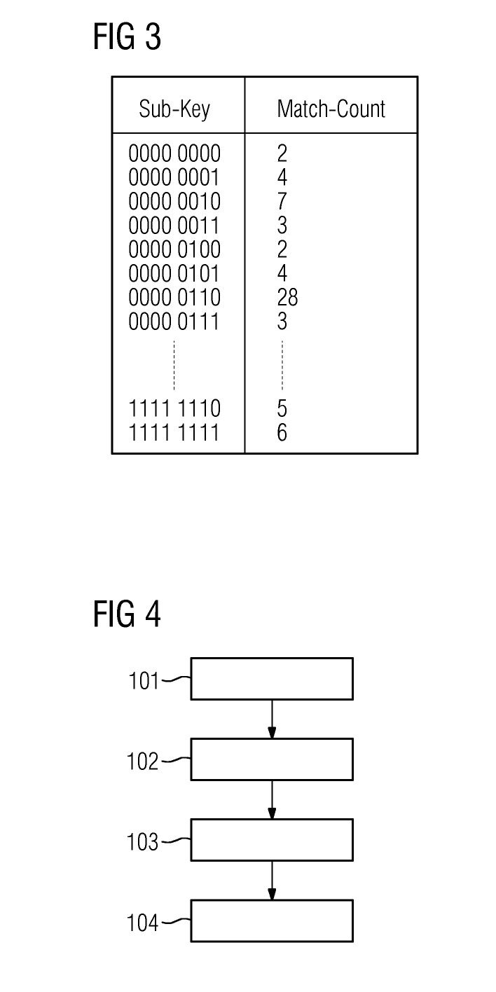

For each possible value of the sub-key 19, a match value may be recorded in a match table, as shown in FIG. 3. In the table illustrated, the entry for the sub-key 0000 0110 (binary) or 6 is the entry with the highest match number. This value would therefore be determined as the sub-key 19.

In one embodiment, the sub-key sequencer 15 repeatedly runs through the sequence of possible sub-key values 19. In one variant, the number of runs depends on how significant the differences are between the top entries in the match table. If, for example, the top 3 sub-key candidates differ only slightly, a new run may be carried out.

In another embodiment, an alternative reference pattern may be used if the difference between the match results is too small. In another embodiment, a plurality of reference patterns are checked during a run. Different challenge value determination rules may likewise be used in the case of a plurality of runs.

The variant illustrated in FIG. 3 provides only a relatively short sub-key (e.g., 8 bits). 4 bits, 6 bits, 10 bits, 12 bits or 16 bits may also be used, for example. The amount of time depends on the bit size since the entire range of values is to be run through.

A longer key KS, for example, with a length of 128 bits or 256 bits may be formed by determining a plurality of sub-keys 19. For this purpose, a different reference pattern is used for each sub-key 19 in one variant. In another variant, a different challenge value calculation rule is used for each sub-key 19.

FIG. 4 shows one embodiment of a method for providing a cryptographic key.

In act 101, a plurality of challenge values CI are determined in this case.

The plurality of challenge values CI are input to a physical unclonable function 11, or the challenge values CI are applied to the physical unclonable function 11 in act 102 in order to generate a plurality of response values RI in response to the challenge values CI.

In act 103, a comparison result is provided by comparing the generated plurality of response values RI with a predefined reference value 18.

Based on the comparison result, one challenge value CI of the plurality of challenge values CI is provided as the cryptographic key 18 in act 104.

Although the present invention is described using exemplary embodiments, the present invention may be modified in a versatile manner.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A circuit unit for providing a cryptographic key, the circuit unit comprising:
a physical unclonable function configured to generate a response value in response to a challenge value;
a determination unit configured to determine a plurality of challenge values and input the plurality of challenge values to the physical unclonable function in order to generate a plurality of response values;
a comparison unit configured to provide a comparison result, the provision of the comparison result comprising a comparison of the generated plurality of response values with a predefined reference value; and
a provision unit configured to provide one challenge value of the plurality of challenge values as the cryptographic key based on the comparison result provided.

2. The circuit unit of claim 1, wherein a response value of the plurality of response values corresponds to a response pattern, and the predefined reference value corresponds to a reference pattern, and
wherein the comparison unit is configured to compare a respective response pattern with the reference pattern.

3. The circuit unit of claim 1, wherein the comparison unit is configured to determine a similarity measure between the plurality of response values and the predefined reference value.

4. The circuit unit of claim 3, wherein the similarity measure includes information relating to a match of a number of bits between a respective response value of the plurality of response values and the predefined reference value.

5. The circuit unit of claim 1, wherein each challenge value of the plurality of challenge values is a fractional value of an overall range of values.

6. The circuit unit of claim 5, wherein the determination unit is configured to select the fractional values from an overall range of values according to a predefined scheme.

7. The circuit unit of claim 1, wherein the one challenge value of the plurality of challenge values that is provided as the cryptographic key is a cryptographic partial key of a complete key.

8. The circuit unit of claim 7, wherein the comparison unit is configured to compare the generated plurality of response values with a plurality of predefined reference values, and wherein the provision unit is configured to determine a plurality of partial keys based on the comparison results.

9. The circuit unit of claim 1, wherein the determination unit is configured to repeatedly input each challenge value of the plurality of challenge values to the physical unclonable function in order to determine a plurality of response values for each challenge value.

10. The circuit unit of claim 1, wherein the provision unit is configured to provide a plurality of possible challenge values.

11. The circuit unit of claim 10, further comprising a test unit configured to check the possible challenge values with the aid of test data, and configured to select one possible challenge value of the plurality of possible challenge values as the cryptographic key.

12. The circuit unit of claim 1, wherein the plurality of response values and the predefined reference value differ in terms of length.

13. The circuit unit of claim 1, wherein the comparison unit is configured to replace the predefined reference value with a further predefined reference value.

14. The circuit unit of claim 2, wherein the comparison unit is configured to determine a similarity measure between the plurality of response values and the predefined reference value.

15. The circuit unit of claim 14, wherein the similarity measure includes information relating to a match of a number of bits between a respective response value of the plurality of response values and the predefined reference value.

16. The circuit unit of claim 15, wherein each challenge value of the plurality of challenge values is a fractional value of an overall range of values.

17. A method for providing a cryptographic key, the method comprising:
determining a plurality of challenge values;
inputting the plurality of challenge values to a physical unclonable function;
generating, by the physical unclonable function, a plurality of response values in response to the plurality of challenge values;
providing a comparison result, the providing of the comparison result comprising comparing the generated plurality of response values with a predefined reference value; and
providing one challenge value of the plurality of challenge values as the cryptographic key based on the comparison result provided.

18. A computer program product comprising a non-transitory computer-readable storage medium storing instructions executable by a program-controlled device to provide a cryptographic key, the instructions comprising:
determining a plurality of challenge values;
inputting the plurality of challenge values to a physical unclonable function;
generating a plurality of response values in response to the plurality of challenge values;
providing a comparison result, the providing of the comparison result comprising comparing the generated plurality of response values with a predefined reference value; and
providing one challenge value of the plurality of challenge values as the cryptographic key based on the comparison result provided.
